(19) United States
(12) Patent Application Publication
(10) Pub. No.: US 2021/0071811 A1
(43) Pub. Date: Mar. 11, 2021

(54) Electronic Shut-Off Device and Method for Shutting Off an Appliance

(71) Applicant: Infineon Technologies AG, Neubiberg (DE)

(72) Inventors: Mahmoud Mohamad Ismail, Muenchen (DE); Manuel Edgar Hollfelder, Muenchen (DE); Mario Alejandro Zotes Orcajo, Muenchen (DE)

(21) Appl. No.: 17/015,715

(22) Filed: Sep. 9, 2020

(30) Foreign Application Priority Data
Sep. 10, 2019 (DE) 102019124230.4

(51) Int. Cl. F16P 3/00

(52) U.S. Cl. CPC F16P 3/00

(57) ABSTRACT

An electronic shut-off device includes an acoustic sensor to detect an acoustic signal from a signaling device, a logic circuit to distinguish the acoustic signal from other sounds, and a trigger to output a shut-off signal as soon as the logic circuit has detected the acoustic signal.

### CROSS-REFERENCE TO RELATED APPLICATIONS

This application claims the benefit of German Application No. 102019124230.4, filed on Sep. 10, 2019, which application is hereby incorporated herein by reference.

### TECHNICAL FIELD

This disclosure relates to an electronic shut-off device and a method for shutting off an appliance.

### BACKGROUND

The risk of fires, the release of toxic gases or chemicals or other hazardous substances, e.g. in buildings, apartments, tunnels, tents, etc. can be reduced by the use of signaling devices, e.g. smoke detectors, gas detectors, heat detectors, etc. However, this requires that the cause of the hazard, e.g. the cause of the fire, is combated promptly as soon as a signaling device has issued an alarm. Due to their sensitivity, signaling devices can trigger already at the stage in which, for example, a fire has not yet started, but there is only an increased presence of smoke. This can be the case, for example, when cooking oil is being heated on a stove. It is only the continued effect of the heat action that actually causes a fire to break out. However, if the heat action is interrupted promptly after the signaling device has been triggered, a fire can be prevented. A timely response may not be possible though if interrupting the heating action requires human intervention, for example, because no one is present who could hear and react to the signaling device. Even if the triggering of the signaling device is detected, the limited human response time can have a negative effect. Improved electronic shut-off devices and improved methods for shutting off an appliance can then help to resolve these and other issues.

The object addressed by the invention is solved by the features of the independent patent claims. Advantageous embodiments and extensions of the invention are described in the dependent claims.

### SUMMARY

Individual examples relate to an electronic shut-off device comprising: an acoustic sensor designed to detect an acoustic signal from a signaling device, a logic circuit designed to distinguish the acoustic signal from other sounds, and a trigger designed to output a shut-off signal as soon as the logic circuit has detected the acoustic signal.

Individual examples relate to a method for shutting off an appliance, said method comprising: detecting an acoustic signal of a signaling device by means of an acoustic sensor, distinguishing the acoustic signal from other sounds by means of a logic circuit, and outputting a shut-off signal by a trigger as soon as the logic circuit has detected an acoustic signal.

### BRIEF DESCRIPTION OF THE DRAWINGS

The attached drawings are examples and, together with the description, serve to explain the basic features of the disclosure. The elements of the drawings are not necessarily drawn to the same scale. The same reference signs may indicate corresponding, similar or identical parts.

FIGS. 1A and 1B show a schematic view of electronic shut-off devices comprising an acoustic sensor, a logic circuit and a trigger;

FIG. 2 shows a side view of another electronic shut-off device, which comprises a carrier on which the components of the electronic shut-off device are arranged;

FIG. 3 comprises FIGS. 3A to 3D and shows further examples of electronic shut-off devices arranged in different ways relative to an appliance to be switched off;

FIG. 4 shows another electronic shut-off device which comprises a memory;

FIG. 5 shows another electronic shut-off device which comprises two units that can communicate wirelessly with each other;

FIG. 6 shows an operational sequence of an electronic shut-off device according to one example; and

FIG. 7 is a flow diagram of a method for shutting off an appliance.

### DETAILED DESCRIPTION OF ILLUSTRATIVE EMBODIMENTS

The following detailed description refers to the drawings and the examples shown therein. For a person skilled in the art, however, it will be evident that one or more aspects of the disclosure may be described with a lesser degree of specific details. In other cases, known structures and elements are shown in schematic form, in order to simplify the description of one or more aspects of the disclosure.

Although a specific feature or a specific aspect of an example may have been disclosed in relation to only one of a plurality of implementations, such a feature or such an aspect can also be combined with one or more other features or aspects of the other implementations, as may be desired and advantageous for a given or specific application, unless specifically stated otherwise or if there is a technical constraint. If the terms “contain”, “possess”, “with” or other variations thereof are used, either in the detailed description or in the claims, these terms shall also have an inclusive meaning in a manner similar to the term “comprise”.

It goes without saying that the features of the various exemplary embodiments described herein can be combined with one another, unless specifically stated otherwise.

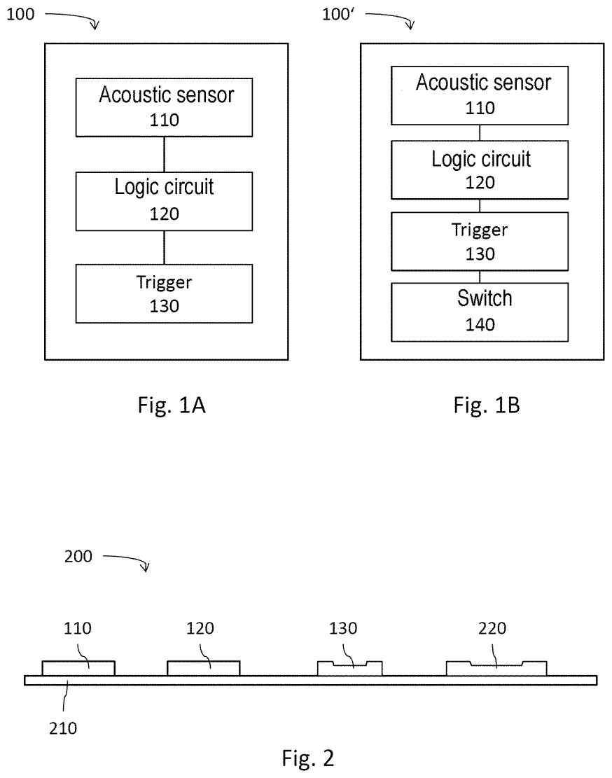

FIG. 1 shows an electronic shut-off device 100 which comprises an acoustic sensor 110, a logic circuit 120 and a trigger 130.

The acoustic sensor 110 is designed to detect an acoustic signal from a signaling device, the logic circuit 120 is designed to distinguish the acoustic signal from other sounds, and the trigger 130 is designed to output a shut-off signal as soon as the logic circuit 120 has detected the acoustic signal.

A signaling device can be, for example, a smoke detector. More generally, a signaling device can also be a warning unit that is designed to output a signal when a source of danger has been detected. Such a source of danger can be, for example, a raised level of heat, a rise in radiation, the release of toxic or environmentally harmful vapors or liquids, etc.

The logic circuit 120 can be designed to detect a warning sound from a signaling device, wherein the warning sound warns of an accumulation of smoke. However, the logic circuit 120 can also be designed to detect other types of acoustic signals from a signaling device, such as a warning of gases or gas concentrations, such as CO₂, CO, methane, temperatures or temperature changes, fluids, or a warning of a low battery level of the signaling device.

The electronic shut-off device 100 can be used, for example, to shut down an electrical appliance, e.g. a kitchen appliance such as a stove, an oven, a microwave, a toaster or perhaps an electric radiator, or even a fuel-powered appliance such as a gas cooker, a gas grill or even a heating unit or heating element, when a signaling device emits the acoustic signal. The electronic shut-off device 100 can be used, for example, to switch off a heat source when a signaling device emits an acoustic signal. In addition, the electronic shut-off device 100 can be used, for example, to close a valve to prevent further flow of gas or a liquid, if e.g. a fire or a leak is detected and a corresponding signal is output by a signaling device. The shut-off device can also be a component of a valve or a fuse.

For example, the electronic shut-off device 100 can be designed to help disconnect an electrical appliance from the mains supply or from a power source, or to disconnect a fuel-powered appliance (e.g. by gas or oil) from the fuel supply. This disconnection can include, for example, the power supply being interrupted or a fuel valve being closed.

According to one example, the shut-off device 100 itself can have a switch that is used to disconnect or instate the power supply, or to close or open the valve. According to another example, the shut-off device 100 is designed only to transmit the shut-off signal to a switch which is not itself part of the shut-off device 100. The switch can comprise, e.g., a relay, a MOSFET or any other suitable switching functionality.

Because the electronic shut-off device 100 can be used to shut down an appliance which is a heat source, the risk of a dangerous fire can be reduced. For example, a signaling device can sound a warning tone as soon as smoke is produced due to excessive heat generation (e.g., on cooking oil on a stove) before a fire has even broken out. The immediate shutdown of the heat source (in this case the stove) without human intervention being required will stop further heating action and can thus prevent a fire from starting.

The acoustic sensor 110 of the electronic shut-off device 100 can be any suitable acoustic sensor, for example a microphone, in particular a silicon microphone.

The logic circuit 120 can be a digital or even an analogue logic circuit, for example. The logic circuit 120 can be implemented e.g., in a microprocessor, a machine-learning IC, an ASIC or in any suitable semiconductor system. According to one example, a logic circuit can also comprise an evaluation unit, in particular an evaluation unit that can comprise a processor. This enables statistical evaluations to influence the behavior of the shut-off device. One or more known patterns that can be fed to the logic circuit can be stored in a memory.

The trigger 130 can comprise any signal output that is suitable for outputting the shut-off signal. For example, the trigger 130 can be designed to output an electrical shut-off signal, a wireless shut-off signal, or an optical shut-off signal. The trigger 130 can therefore be connected, for example, by wired means or wirelessly to the above-mentioned switch for disconnecting or instating the power supply or the fuel supply.

According to one example, the electronic shut-off device 100 can be designed to itself control the power supply or the valve. This means that the power supply may be switched on or the valve may be open when the electronic shut-off device 100 is switched on and the power supply may be switched off or the valve closed when the electronic shut-off device 100 is switched off. In this case, the electronic shut-off device 100 can be designed to be switched off itself by the shut-off signal, thereby disconnecting the power supply or closing the valve.

FIG. 1B shows an electronic shut-off device 100′, which may be identical to the electronic shut-off device 100, except that the electronic shut-off device 100′ also comprises a switch. The switch 140 can be designed to trigger the powering-on or powering-off of the electronic shut-off device 100′ and/or of the appliance to be shut off. The switch 140 can be user-controlled or time-controlled. For example, a user-controlled switch 140 can comprise a button that allows a user to switch on the electronic shut-off device 100′ again. A user-controlled switch 140 can be designed, for example, for a user to activate the switch 140 when the shut-off signal is present (the presence of the shut-off signal can be communicated to the user, for example, by means of a warning light and/or a warning signal). A time-controlled switch 140 can comprise, for example, a timing circuit that switches the electronic shut-off device on again after a specified time period has elapsed, or at a specified time.

FIG. 2 shows an electronic shut-off device 200, which can be similar or identical to the electronic shut-off devices 100 and 100′.

The electronic shut-off device 200 is designed as a semiconductor module comprising a carrier 210 and components arranged thereon. The carrier 210 can comprise, for example, a printed circuit board (PCB). The components can be electrically connected to each other by means of conductor tracks of the carrier.

According to an example, the acoustic sensor 110 and the logic circuit 120 can be arranged on the carrier 210 as two separate components (as shown in FIG. 2). However, it is also possible that the acoustic sensor 110 and the logic circuit 120 are integrated in a common component, e.g. monolithically.

The electronic shut-off device 200 may have other components which can be arranged on the carrier 210, e.g. a connector 220. The connector 220 can be used to supply voltage to the electronic shut-off device 200. However, it is also possible that the electronic shut-off device 200 has an internal voltage source, such as a battery, instead of or in addition to the connector 220.

The electronic shut-off device 200 can be designed to be installed in the appliance to be switched off. The appliance to be switched off (e.g., a stove) can have, e.g., a control electronics and the electronic shut-off device 200 can be part of the control electronics. However, it is also possible that the electronic shut-off device 200 is not part of a control electronics of the appliance to be switched off and can be installed in the appliance to be switched off as a separate component.

According to another example, the electronic shut-off device 200 is not designed to be installed in the appliance to be switched off. Instead, the electronic shut-off device 200 can be designed to be arranged between an electrical mains plug or mains connection of the appliance to be shut off and a mains supply or a socket, or in the socket, or in an electrical fuse or on a valve.

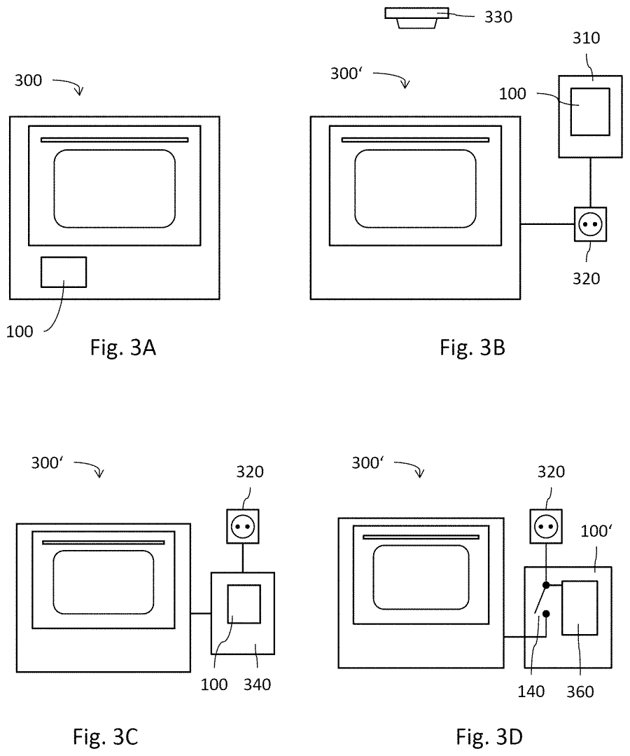

In FIGS. 3A to 3C, various examples are shown of ways in which the electronic shut-off device 100 or 200 and an appliance to be switched off can be arranged with respect to each other.

FIG. 3A shows an example according to which the electronic shut-off device 100 or 100′ (or else 200) is integrated into the appliance 300 to be switched off.

The appliance 300 can be designed, for example, to have the electronic shut-off device 100 to be already installed during its production. However, it is also possible that the appliance 300 and/or the electronic shut-off device 100 are designed such that the appliance 300 is retrofitted with the electronic shut-off device 100.

FIG. 3B shows an example according to which the electronic shut-off device 100 or 100′ is not integrated into the appliance 300′ to be switched off, but is integrated into an external fuse 310. For example, the external fuse 310 can be a fuse box.

The appliance 300′ to be switched off can be connected to a mains outlet 320 which is protected by the external fuse 310. In the event that the electronic shut-off device detects an acoustic signal from a signaling device 330 and outputs a shut-off signal, the mains outlet 320 is disconnected from the mains supply by the external fuse 310 and the appliance 300′ is therefore switched off.

FIG. 3C shows another example, according to which the electronic shut-off device 100 or 100′ is arranged outside the appliance 300′.

In the case of FIG. 3C, the electronic shut-off device 100 may be designed to be arranged between the appliance 300′ and the mains outlet 320. The electronic shut-off device 100 may be designed to be part of an intermediate device 340 located between the appliance 300′ and the mains outlet 320.

The intermediate device 340 can be, for example, an extension socket or a multi-way socket, wherein a mains plug of the appliance 300′ is connected to the extension socket or multi-way socket and the latter is in turn connected to the mains outlet 320.

FIG. 3D shows another example according to which the appliance 300′ is connected to the electronic shut-off device 100′. The electronic shut-off device 100′ has the switch 140, which can be designed to disconnect or instate the connection from the appliance 300′ to the mains outlet 320. The electronic shut-off device 100′ can also comprise other components 360, e.g. the acoustic sensor 110, logic circuit 120 and trigger 130. The switch 140 can be designed to be operated manually, or else to disconnect or restore the connection to the mains outlet 320 automatically (e.g., when the shut-off signal is output by the trigger 130).

The examples shown in FIGS. 3B to 3D can have the advantage that the appliance 300′ does not have to be equipped or retrofitted with the electronic shut-off device 100 or 100′. For example, due to space or cost reasons, it may not be possible or practical to integrate the electronic shut-off device 100 or 100′ into the appliance 300′. The example shown in FIG. 3A, on the other hand, can have the advantage that the electronic shut-off device 100 or 100′ in the appliance 300 is ready for use without further steps being necessary, such as installation in the external fuse 310 or use of the intermediate device 340.

According to the examples shown in FIGS. 3B to 3D, the appliance 300′ to be switched off is connected to a power outlet 320. However, according to another example this connector can also be a gas connection or an oil connection. According to another example, it may be a connection controlled by a valve.

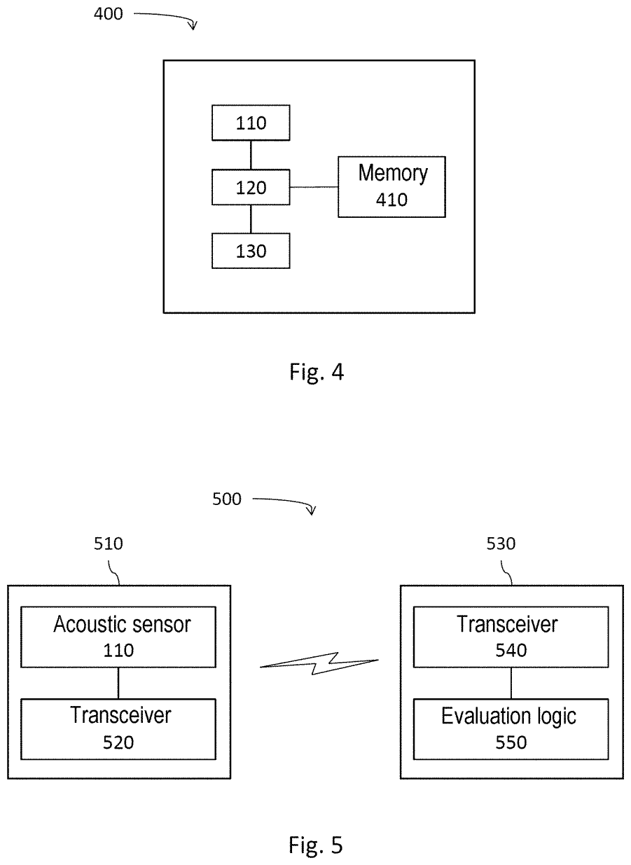

FIG. 4 shows another electronic shut-off device 400, which can be similar or identical to the electronic shut-off devices 100, 100′ and 200, apart from the differences described in the following.

The electronic shut-off device 400 has the acoustic sensor 110, the logic circuit 120 and the trigger 130 and additionally a memory 410. The memory 410 can also be connected to the logic circuit 120, for example.

According to one example, the memory 410 can be arranged on the carrier 210 together with the acoustic sensor 110, the logic circuit 120 and the trigger 130 (see FIG. 2). The memory 410 can be connected to the logic circuit 120, for example via the carrier 210.

The memory 410 can be any suitable type of memory and it can be designed to provide read-only access, or the memory 410 can allow both read and write access.

The memory 410 can be designed to store characteristics of acoustic signals from signaling devices. These characteristics can be determined in advance, for example, and loaded into the memory 410 during the manufacture of the electronic shut-off device 400. However, it is also possible that the electronic shut-off device 400 is designed to be trained on the acoustic signals of signaling devices. For example, the electronic shut-off device 400 can be designed to be trained on the acoustic signals of a specific signaling device used in the respective household. It is also possible that the electronic shut-off device 400 is designed to retrospectively receive an update, which comprises new characteristics, for example.

The logic circuit 120 can be designed to decide whether a signal detected by the acoustic sensor 110 has the characteristics. For this purpose, the logic circuit 120 can be designed to access the memory 410 and compare a detected signal with the stored characteristics.

According to one example the characteristics can comprise a sound frequency range and/or a signal duration and/or a sound volume. The sound frequency range can cover, for example, the range audible to human beings and can cover, e.g., 2.5 kHz or more, in particular 2.5 kHz to 4 kHz. The signal duration can be, e.g., is or more, 2 s or more, 3 s or more, and/or be a periodically recurring tone. The volume can be, for example, 80 dB or more or 90 dB or more.

According to one example, a detected signal that has individual or all of the characteristics can be identified by the logic circuit 120 as an acoustic signal of a signaling device.

FIG. 5 shows another example of an electronic shut-off device 500, which can be similar or identical to the electronic shut-off devices 100, 100′, 200 and 400, apart from the differences described in the following.

The electronic shut-off device 500 comprises a first unit 510, which comprises the acoustic sensor 110 and a transceiver 520. The first unit 510 can be designed to be integrated into an appliance to be switched off. For example, the first unit 510 can comprise a semiconductor module with a carrier 210, as shown in FIG. 2.

The first unit 510 can be designed to detect an acoustic signal from a signaling device by means of the acoustic sensor 110 and to transmit data wirelessly from the acoustic signal to a second unit 530 of the electronic shut-off device 500 using the transceiver 520. The wireless transmission can be carried out according to a WLAN or Bluetooth standard, for example. According to a different design, the data can be transmitted by means of a wired transmission, such as the so-called Powerline communication.

The second unit 530 can include an additional transceiver 540 and an evaluation logic 550. The transceiver 540 can be designed to receive the data about the acoustic signal and the evaluation logic 550 can be designed to distinguish an acoustic signal of a signaling device from other sounds. The evaluation logic 550 can be designed identically similarly or identically to the logic circuit 110.

The second unit 530 can be a central unit that is designed to enter into communication with a plurality of first units 510. According to one example, the second unit 530 can be designed to be housed in a building, a household, an apartment, a factory, an industrial plant, a tunnel, a tent, etc. together with the one or more first unit(s) 510. According to another example, the second unit 530 may not be accommodated in the household, but can be supplied by a provider. In this case, the second unit 530 can communicate with first units 510 of a plurality of households, buildings, apartments, factories, industrial facilities, tunnels, tents, etc., e.g. via the internet. The second unit 530 can also be partly or completely implemented by software and instead of the transceiver 540 can also use transceiver devices of internet access points.

In the event that the evaluation logic 550 detects an acoustic signal of a signaling device, the second unit 530 can send a shut-off signal to the first unit 510.

According to one example, it is also possible that the first unit does not comprise a transceiver 520, but only a transmitter. In this case, an additional unit may be provided in the electronic shut-off device 500, comprising a receiver and a switch for disconnecting the power supply or the fuel supply. According to a different design, the switch can be designed to operate independently of the receiver, for example by manual actuation. The switch can be implemented, for example, as a semiconductor switch. Preferably, the semiconductor switch can be based on semiconductor materials such as GaN, SiC, Si, or semiconductor technologies such as MOSFET, IGBT, bipolar technologies, etc.

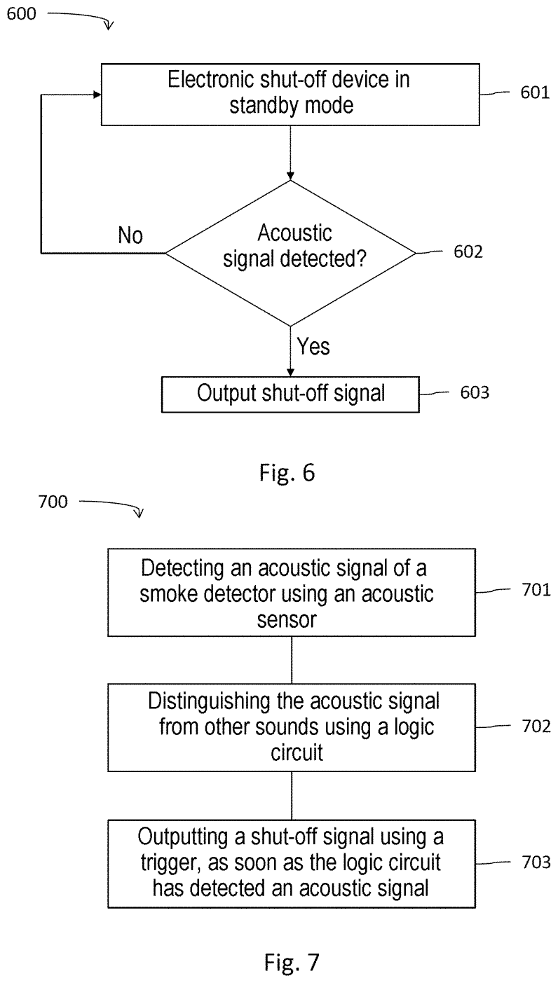

FIG. 6 shows an operating sequence 600 of an electronic shut-off device (e.g., an electronic shut-off device 100, 100′, 200, 400 or 500) according to an example.

At 601, the electronic shut-off device is in the standby mode. At 602, for example, a logic circuit of the electronic shut-off device decides whether an acoustic signal of a signaling device has been detected. This may include the logic circuit identifying a received sound as such an acoustic signal or as another type of sound.

If no acoustic signal of a signaling device is detected, the electronic shut-off device remains in the standby mode. However, if an acoustic signal of a signaling device has been detected, a shut-off signal is output at 603.

FIG. 7 is a flow diagram of a method 700 for shutting off an appliance. The method 700 can be implemented, for example, by means of one of the electronic shut-off devices 100, 100′, 200, 400 or 500.

The method 700 comprises at 701 detecting an acoustic signal of a signaling device by means of an acoustic sensor, at 702 distinguishing the acoustic signal from other sounds by means of a logic circuit, and at 703 outputting a shut-off signal by a trigger as soon as the logic circuit has detected an acoustic signal.

According to one example, the method 700 can also comprise a filtering of sounds received by the acoustic sensor in order to analyze a specific frequency range and/or a specific minimum volume of the received sounds by the logic circuit. In addition, the method 700 can comprise storing characteristics of acoustic signals from signaling devices in a memory, as well as determination by the logic circuit whether a signal detected by the acoustic sensor has the characteristics.

In the following the electronic shut-off device and the method for shutting off an appliance are explained in more detail using explicit examples.

Example 1 is an electronic shut-off device, comprising: an acoustic sensor designed to detect an acoustic signal from a signaling device, a logic circuit designed to distinguish the acoustic signal from other sounds, and a trigger designed to output a shut-off signal as soon as the logic circuit has detected the acoustic signal.

Example 2 is the electronic shut-off device according to example 1, wherein the electronic shut-off device is designed to be installed in the appliance to be shut off.

Example 3 is the electronic shut-off device according to example 1, wherein the electronic shut-off device can be arranged between an electrical mains connector of the appliance to be shut off and a mains supply or a socket, or in the socket or in an electrical fuse or on a valve.

Example 4 is the electronic shut-off device according to one of the preceding examples, wherein the shut-off signal can switch off the shut-off device.

Example 5 is the electronic shut-off device according to one of the preceding examples, also comprising: a switch that can trigger a powering-on or powering-off of the shut-off device.

Example 6 is the electronic shut-off device according to example 5, wherein the switch is user-controlled or time-controlled.

Example 7 is the electronic shut-off device according to one of the preceding examples, also comprising: a memory designed to store characteristics of acoustic signals of signaling devices, the logic circuit being designed to decide whether a signal detected by the acoustic sensor has the characteristics.

Example 8 is the electronic shut-off device according to example 7, wherein the characteristics comprise a sound frequency range and/or a signal duration and/or a sound volume.

Example 9 is the electronic shut-off device according to example 1, wherein the electronic shut-off device is designed to be supplied with voltage by the appliance to be shut off.

Example 10 is the electronic shut-off device according to one of the preceding examples, wherein all components of the electronic shut-off device are arranged on a common carrier.

Example 11 is the electronic shut-off device according to example 10, wherein the common carrier is a circuit board.

Example 12 is an electrical appliance, comprising: an electrical connection for connecting the appliance to be switched off to a mains supply, and an electronic shut-off device according to example 1.

Example 13 is the electrical device according to example 12, wherein the appliance to be switched off is a device for generating heat.

Example 14 is the electrical appliance according to example 13, wherein the device is a stove, a toaster, an oven, a microwave, a radiant heater or a valve.

Example 15 is a method for shutting off an appliance, the method comprising: detecting an acoustic signal of a signaling device by means of an acoustic sensor, distinguishing the acoustic signal from other sounds by means of a logic circuit, and outputting a shut-off signal by a trigger as soon as the logic circuit has detected an acoustic signal.

Example 16 is the method according to claim 15, wherein the acoustic sensor, the logic circuit and the trigger are installed in the appliance to be switched off.

Example 17 is the method according to example 15 or 16, further comprising: filtering sounds received by the acoustic sensor to analyze a specific frequency range and/or a minimum volume of the received sounds using the logic circuit.

Example 18 is the method according to one of the examples 15 to 17, further comprising: storing characteristics of acoustic signals from signaling devices in a memory and determining by means of the logic circuit whether a signal detected by the acoustic sensor has the characteristics.

Example 19 is the method according to one of the examples 15 to 18, further comprising: wireless or wired communication of data about the acoustic signal to an evaluation unit, evaluation of the data in the evaluation unit, and wireless or wired communication of a command to the trigger to output the shut-off signal.

Example 20 is the method according to one of the examples 15 to 19, further comprising: supplying the acoustic sensor, the logic circuit and the trigger with voltage from a mains supply.

Although specific embodiments have been shown and described herein, it is obvious to the person of average skill in the art that a plurality of alternative and/or equivalent implementations can replace the specific examples shown and described, without departing from the scope of the present disclosure. This application is intended to include all modifications or variations of the specific examples discussed herein. It is therefore intended that this disclosure is limited only by the claims and their equivalents.

What is claimed is:

1. An electronic shut-off device, comprising:
an acoustic sensor designed to detect an acoustic signal from a signaling device,
a logic circuit designed to distinguish the acoustic signal from other sounds, and
a trigger designed to output a shut-off signal as soon as the logic circuit has detected the acoustic signal.

2. The electronic shut-off device as claimed in claim 1, wherein the electronic shut-off device is designed to be installed in an appliance to be shut off.

3. The electronic shut-off device as claimed in claim 1, wherein the electronic shut-off device can be arranged between an electrical mains connection of an appliance to be shut off and a mains supply, or a socket, or in the socket, or in an electrical fuse, or on a valve.

4. The electronic shut-off device as claimed in claim 1, wherein the shut-off signal can switch off the shut-off device.

5. The electronic shut-off device as claimed in claim 1, further comprising:
a switch that can trigger a powering-on or powering-off of the shut-off device.

6. The electronic shut-off device as claimed in claim 5, wherein the on switch is user-controlled or time-controlled.

7. The electronic shut-off device as claimed in claim 1, further comprising:
a memory designed to store characteristics of acoustic signals of signaling devices,
wherein the logic circuit is designed to decide whether a signal detected by the acoustic sensor has the characteristics.

8. The electronic shut-off device as claimed in claim 7, wherein the characteristics comprise a sound frequency range and/or a signal duration and/or a sound volume.

9. The electronic shut-off device as claimed in claim 1, wherein the electronic shut-off device is designed to be supplied with voltage by an appliance to be shut off.

10. The electronic shut-off device as claimed in claim 1, wherein all components of the electronic shut-off device are arranged on a common carrier.

11. The electronic shut-off device as claimed in claim 10, wherein the common carrier is a printed circuit board.

12. An electrical appliance, comprising:
an electrical connection for connecting an appliance to be switched off to an electrical mains supply, and
an electronic shut-off device as claimed in claim 1.

13. The electrical appliance as claimed in claim 12, wherein the appliance to be switched off is a device for generating heat.

14. The electrical appliance as claimed in claim 13, wherein the appliance is a stove, a toaster, an oven, a microwave, a valve, a fuse, or a radiant heater.

15. A method for shutting off an appliance, said method comprising:
detecting an acoustic signal of a signaling device by an acoustic sensor,
distinguishing the acoustic signal from other sounds by means of a logic circuit, and
outputting a shut-off signal by a trigger as soon as the logic circuit has detected an acoustic signal.

16. The method as claimed in claim 15, further comprising:
shutting off the appliance under control of a user when the shut-off signal is present.

17. The method as claimed in claim 15, wherein the acoustic sensor, the logic circuit and the trigger are installed in the appliance to be switched off.

18. The method as claimed in claim 15, further comprising:
filtering sounds received by the acoustic sensor to analyze a specific frequency range and/or a specific minimum volume of the received sounds using the logic circuit.

19. The method as claimed in any one of claims 15, further comprising:
storing in a memory characteristics of acoustic signals from signaling devices, and
determining by means of the logic circuit whether a signal detected by the acoustic sensor has the characteristics.

20. The method as claimed in any one of claims 15, further comprising:
wireless or wired communication of data about the acoustic signal to an evaluation unit,
evaluation of the data in the evaluation unit, and
wireless or wired communication of a command to the trigger to output the shut-off signal.

21. The method as claimed in any one of claims 15, further comprising:
supplying the acoustic sensor, the logic circuit and the trigger with voltage from a mains supply.
